(19) United States
(12) Patent Application Publication
(10) Pub. No.: US 2009/0043937 A1
(43) Pub. Date: Feb. 12, 2009

(54) Three-Dimensional Interconnection Architecture For Multiprocessor Computer

(75) Inventors: Mario J.D. Lee, Taoyuan (TW); Tomonori Hirai, Taoyuan (TW); Jyh Ming Jong, Taoyuan (TW)

Correspondence Address: APEX JURIS, PLLC, 12360 LAKE CITY WAY NORTHEAST, SUITE 410, SEATTLE, WA, 98125, US

(73) Assignee: MITAC INTERNATIONAL CORP., Taoyuan (TW)

(21) Appl. No.: 11/835,442

(22) Filed: Aug. 8, 2007

(51) Int. Cl. G06F 13/14

(52) U.S. Cl. 710/305

(57) ABSTRACT

A three dimensional interconnection architecture is provided for a multiprocessor computer. The interconnection architecture includes multiple processor boards, one or more interconnection board and one or more edge board. The processor boards are configured parallel to each other, each having plural processors configured thereon. The interconnection board is connected with one side of each of the processor boards to allow one of the processors on one of the processor boards operatively connecting with another one of the processors on another one of the processor boards. The edge board is connected with another side of each of the processor boards to allow one of the processors on one of the processor boards operatively connecting with another one of the processors on another one of the processor boards.

### FIELD OF INVENTION

The present invention relates to a physical interconnection architecture of a computer system, and more particularly, to a three-dimensional interconnection architecture for a multiprocessor computer.

### BACKGROUND

Traditional physical design for a scaleable multiprocessor computer requires many interconnections over short distances to fulfill performance and architectural requirements. The required number of interconnection signals increases exponentially in a symmetric multiprocessor system where each processor requires connections to each and every other processor. Generally, performance penalties are paid when the number and length of signal traces exceed the requirements due to physical limitations of the maximum traces and components can be placed in close proximity to each other. The performance penalties can come in longer trace lengths which increase the time it takes for signals to reach the target component.

An example is in a traditional back plane design where many CPU boards are directly plugged onto. As the number of boards increase, the space and trace length from one end of the stack of boards to the other end increases. This limits the number of boards for a given system performance and maximum trace length requirements. Another limitation is the board edge length needed for connectors to meet the number of internal routed signals. This forces the board size to grow and limit the size and scale a computer that can be built economically. These requirements have driven existing designs toward many expensive approaches to get around this problem.

One way to make the connection is by routing the signals to go through another processor or device before reaching the desired processor. Another method is by adding repeater or switching chips in the system architecture, which adds cost and complexity and performance penalty to the system. All these type of approaches add cost, components and complexity to the system. These alternate approaches also add complexity and to the mechanical and cooling design and together limit the ability to design and built commercially viable high performance multiprocessor computer for volume production.

### SUMMARY

To solve the prior art problems mentioned above, the present invention is provided to allow many more interconnections being made in the same space. The present invention also overcomes the bottle neck problem of trace length when the number of boards increases. Meanwhile, conventional-size boards and connectors can be utilized in the present invention without custom-made specialty or exotic parts/technologies. This design facilitates easy assembly and service without complex mechanical framework.

In an embodiment of the present invention, a three dimensional interconnection architecture is provided for a multiprocessor computer. The interconnection architecture includes multiple processor boards, one or more interconnection board and one or more edge board. The processor boards are configured parallel to each other, each having plural processors configured thereon. The interconnection board is connected with one side of each of the processor boards to allow one of the processors on one of the processor boards operatively connecting with another one of the processors on another one of the processor boards. The edge board is connected with another side of each of the processor boards to allow one of the processors on one of the processor boards operatively connecting with another one of the processors on another one of the processor boards.

In another embodiment of the present invention, the edge board includes multiple edge connectors for connecting with the processor boards. The edge board further includes plural trace connections to connect one of the edge connectors with another of the edge connectors.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The present invention can be more fully understood by reference to the following description and accompanying drawings, in which:

FIG. 1 is a schematic view for a three-dimensional interconnection architecture of a multiprocessor computer according to an embodiment of the present invention.

FIG. 2 shows a block diagram for the interconnection architecture illustrated in FIG. 1.

FIG. 3 shows another block diagram for the interconnection architecture illustrated in FIG. 1.

FIG. 4 is a schematic view for a three-dimensional interconnection architecture of a multiprocessor computer according to another embodiment of the present invention.

FIG. 5 shows a block diagram for the interconnection architecture illustrated in FIG. 4.

FIG. 6 shows a block diagram for the interconnection architecture illustrated in FIG. 4.

FIG. 7 is a schematic view for a three-dimensional interconnection architecture of a multiprocessor computer according to another embodiment of the present invention.

FIG. 8 shows a block diagram for the interconnection architecture illustrated in FIG. 7.

FIG. 9 shows a block diagram for the interconnection architecture illustrated in FIG. 7.

### DETAILED DESCRIPTION

Reference will now be made in detail to the present preferred embodiments of the invention, examples of which are illustrated in the accompanying drawings. Wherever possible, the same reference numbers are used in the drawings and the description refers to the same or the like parts.

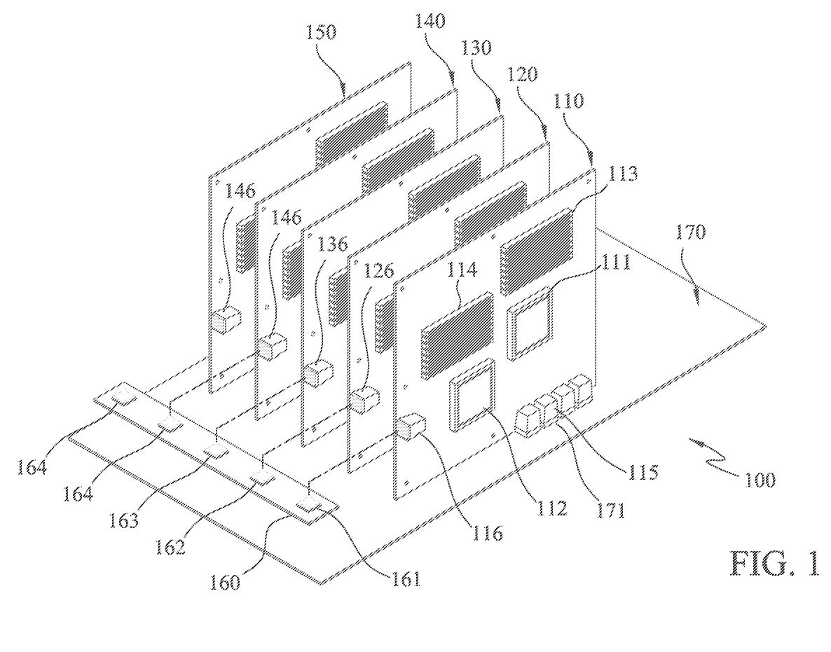

Please refer to FIG. 1. In the embodiment a multiprocessor computer 100 includes three types of boards: multiple (five) processor boards 110,120,130,140,150, one (or more) interconnection board 170 and one (or more) edge board 160, all linked together as a three-dimensional interconnection architecture. The multiprocessor computer in the present invention is to facilitate HPC (High Performance Calculation), such as symmetric multiprocessing (SMP), clustering and parallel calculating capabilities.

The processor boards 110,120,130,140,150 all have similar structures. Take the processor board 110 as an example. The processor board 110 mainly includes multiple (two) processors 111,112, or so-called CPU (Central Processing Unit), and system memories 113,114 connected to the processors 111,112 respectively. On the same processor board, each of the processors connects with at least another one processor. Multiple “first side connectors” 115 in FIG. 1 are configured at a first side (the bottom side) of the processor board 110 to connect to the interconnection board 170. The first side connectors 115 on the processor board 110 are operatively connected (not shown) to the processor 111,112. It is similar on the other processor boards 120,130,140,150. The first side connectors (not shown) on the other processor boards 120 (130,140 or 150) operatively connect with the processors on the same processor board 120 (130,140 or 150) and the interconnection board 170. In FIG. 1, all the processor boards 110,120,130,140,150 are configured parallel to each other, and also configured orthogonally and vertically on the interconnection board 170.

The interconnection board 170 is used to facilitate a so-called traditional backplane or bottom-plane layout. To connect the processor boards together, the interconnection board 170 includes multiple interconnection connectors (not shown) configured on the top surface of the interconnection board 170 for connecting with the side connectors of the processor boards. This interconnection board 170 can be a passive interconnecting board or be populated with active devices such as I/O devices or other devices.

The edge board 160 is a long board with multiple edge connectors 161,162,163,164, to connect with a second side (left side in FIG. 1) of each of the processor boards 110,120,130,140,150. On each of the processor boards 110,120,130,140,150, another side connector 116 (126,136,146,) is configured at the second side of each of the processor boards 110,120,130,140,150 to connect between at least one of the processors on each of the processor boards 110,120,130,140,150 and the edge connector 161 (162,163,164,) of the edge board 160.

In FIG. 1, each type of boards represents one interconnection dimension: the processor boards 110,120,130,140,150 are the first dimension; the interconnection board 170 is the second dimension; and the edge board 160 is the third dimension. In view of trace connections between processors, there are also three dimensions: (1) trace connections on the same processor board; (2) trace connections on the interconnection board; (3) trace connections on the edge board.

Generally, one of the processor boards 110,120,130,140,150 may be used as a head node and the rest of processor boards are computation node. With the three dimensional interconnection architecture of the present invention, the multiprocessor computer 100 facilitates scalable and flexible HPC capability. Meanwhile, since not all connections are configured through the same interconnection board, the present invention overcomes the bottle neck problem of trace length when the number of boards increases. Besides, in the present invention, all the side connectors, interconnection connectors and edge connectors may just use commercially available connectors, such as FCI Airmax connectors.

In actual implementation, keeping all the connectors close to the corners of the processor boards will achieve a maximum flexibility in the opposite corners where the edge board(s) is attached in the third dimension. Arrangements closer to the corners allows maximum mechanical tolerance in the orthogonal dimensions for proper mating of the edge board. Moreover, we can use one or more edge boards to connect with each of a third sides (top sides in FIG. 1) or fourth sides (right sides in FIG. 1) of the processor boards.

The edge board 160 in FIG. 1 provides multiple types of interconnections, depending on the trace connections (or simply “bus”).

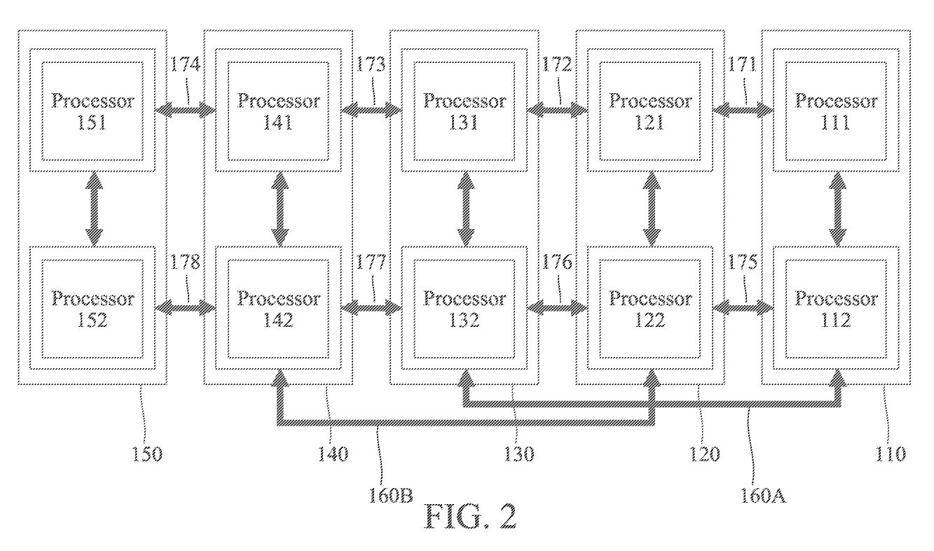

Please refer to FIG. 2 for the first type. Each pair of processors 111-112, 121-122, 131-132, 141-142, 151-152 has trace connections to communicate with the other processor on each of the processor board 110,120,130,140,150. The interconnection board 170 in FIG. 1 provides trace connections 171, 172, 173,174,175,176,177,178 to form interconnections between processors 111 and 121, 121 and 131, 131 and 141, 141 and 151, 112 and 122, 122 and 132, 132 and 142, 142 and 152 respectively. In FIG. 2 the trace connections 160A and 160B are provided by the edge board 160 in FIG. 1. The trace connection 160A is formed between the edge connectors 161 and 163. The trace connection 160B, similarly, is formed between the edge connectors 162 and 164. That means there are four processors connected as two pairs: processors 112-132 and 122-142.

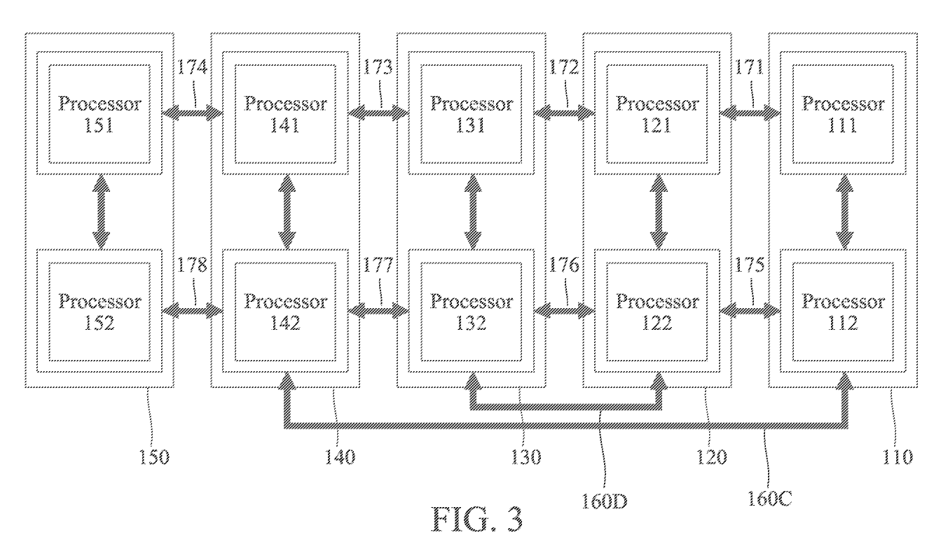

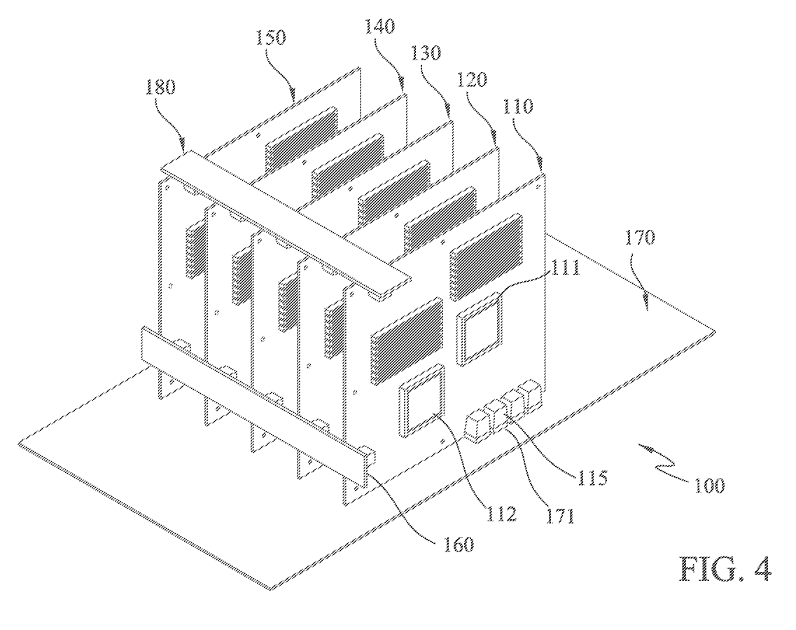

Please refer to FIG. 3. The trace connections 160C and 160D are also provided by the edge board 160 in FIG. 1, only with different type of trace connections. The trace connection 160C is formed between the edge connectors 161 and 164. The trace connection 160D, similarly, is formed between the edge connectors 162 and 163. That means there are four processors connected as two pairs: processors 112-132 and 122-142. Other type of trace connections, except FIGS. 3 and 4 for the edge board 160 in FIG. 1, are easy to implement by those skilled in the art and are omitted herein.

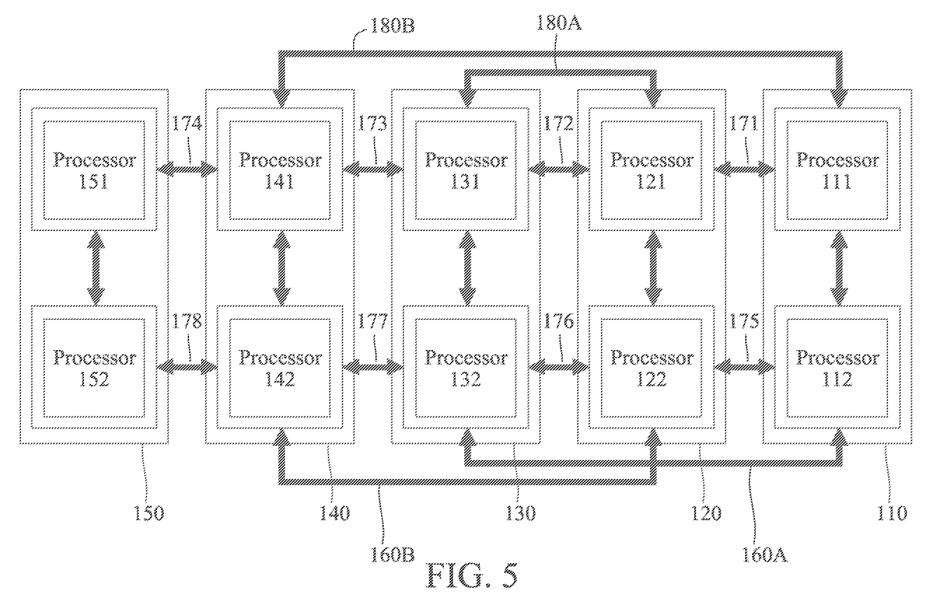

Please refer to FIG. 4. Another edge board 180 is configured and added to connect with the third sides (top sides) of the processor boards 110,120,130,140,150. Therefore, in FIG. 5, the trace connections 160A, 160B may be provided by the edge board 160 at the second sides (left sides in FIG. 4) of the processor boards 110,120,130,140,150; the trace connections 180A, 180B may be from the edge board 180 at the third sides (top sides in FIG. 4) of the processor boards 110,120,130,140,150.

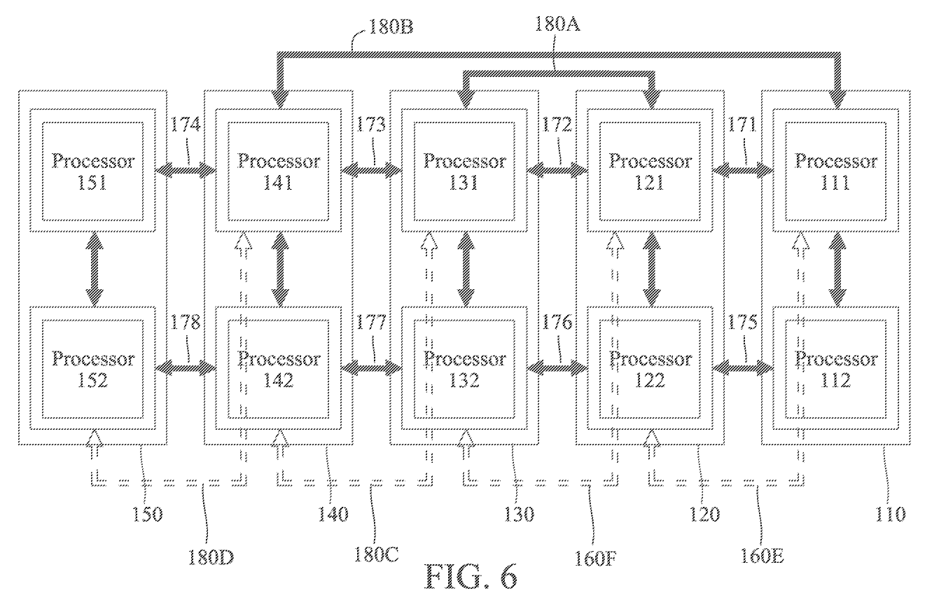

Another type of trace connections is disclosed in FIG. 6. The trace connections 160E and 160F are used to connect with two pairs of processors 111-122, 121-132 respectively. And trace connections 180C and 180D are used to connect with two pairs of processors 131-142, 141-152 respectively. In FIG. 6, each of the trace connections allows to connect the processors located at diagonal positions. The aforesaid trace connections may be provided by any arrangement of the edge board 160 or 180 and should not be limited to those disclosed in the description and the drawings.

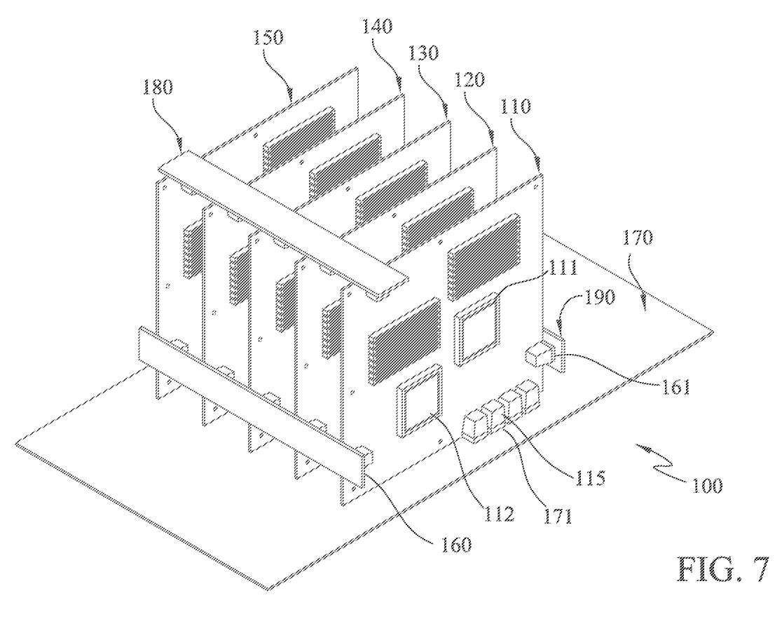

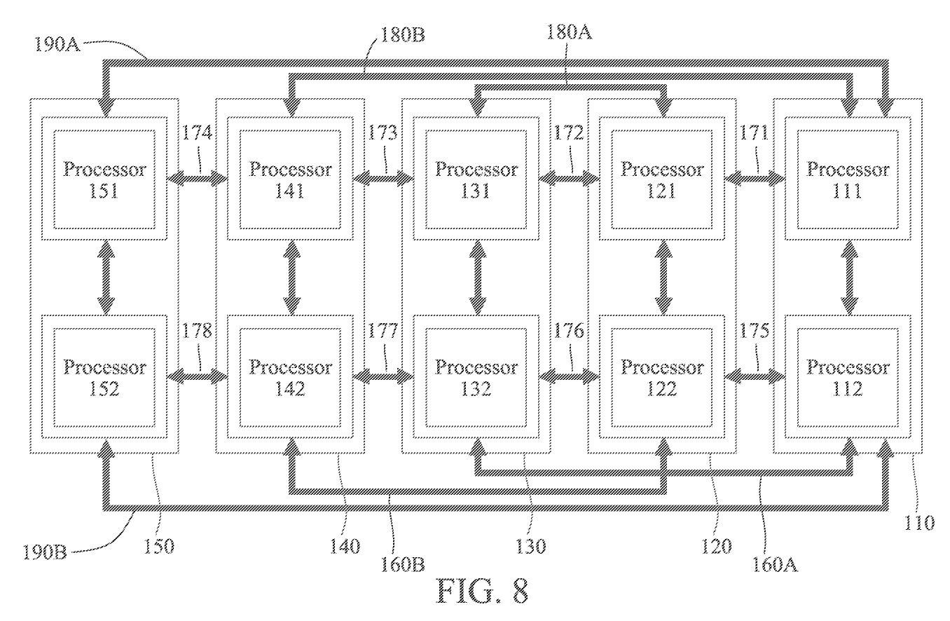

Please refer to FIG. 7. Another edge board 190 is configured and added to connect with the fourth sides (right sides) of the processor boards 110,120,130,140,150. Therefore, in FIG. 8, the trace connections 160A, 160B may be provided by the edge board 160 at the second sides (left sides in FIG. 7) of the processor boards 110,120,130,140,150; the trace connections 180A, 180B may be from the edge board 180 at the third sides (top sides in FIG. 7) of the processor boards 110,120,130,140,150; the trace connections 190A, 190B may be from the edge board 190 at the fourth sides (right sides in FIG. 7) of the processor boards 110,120,130,140,150.

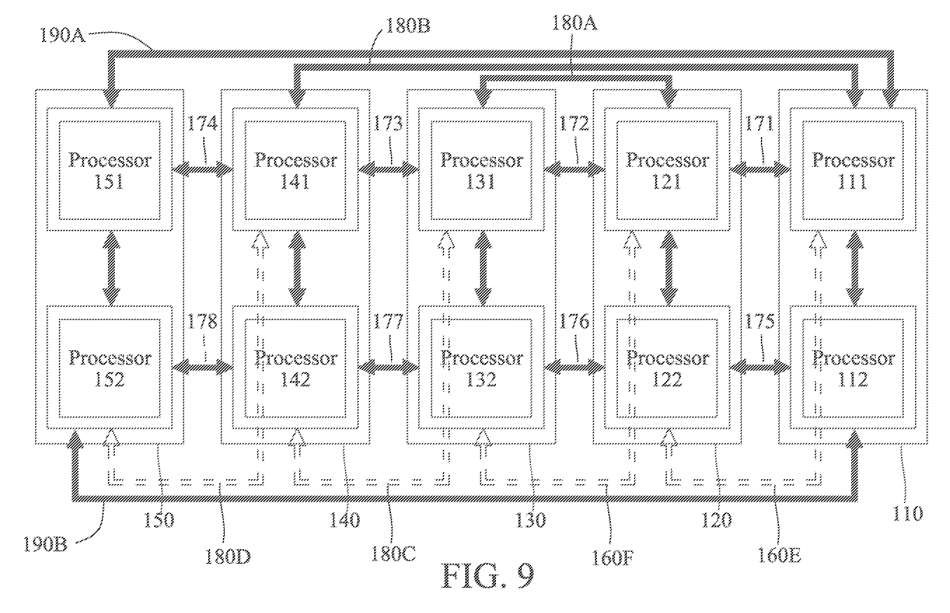

Another type of trace connections is disclosed in FIG. 9. The trace connections 160E and 160F are used to connect with two pairs of processors 111-122, 121-132 respectively. And trace connections 180C and 180D are used to connect with two pairs of processors 131-142, 141-152 respectively. The trace connections 190A and 190B are used to connect with two pairs of processors 111-151, 112-152 respectively. In FIG. 9, some of the trace connections allow to connect the processors located at diagonal positions. The aforesaid trace connections may be provided by any arrangement of the edge board 160 or 180 or 190 and should not be limited to those disclosed in the description and the drawings.

Obviously, the edge board increase direct connection between processors. Namely, with the interconnection architecture of the present invention, the legacy between processors will be dramatically decreased. Except configured on the second, third, fourth sides of the processor boards, more than one edge board may be configured on the same sides of processor boards. Besides, the interconnection board and the edge board(s) may be connected respectively to adjacent orthogonal sides of each of the processor boards.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An interconnection architecture for a multiprocessor computer, comprising:
a plurality of processor boards configured parallel to each other, each having a plurality of processors configured thereon;
at least one interconnection board, connected with one side of each of the processor boards to allow at least one of the processors on one of the processor boards operatively connecting with at least another one of the processors on another one of the processor boards; and
at least one edge board, connected with another side of each of the processor boards to allow at least one of the processors on one of the processor boards operatively connecting with at least another one of the processors on another one of the processor boards.

2. The interconnection architecture of claim 1, wherein the interconnection board and the edge boards are connected respectively with two opposite sides of each of the processor boards.

3. The interconnection architecture of claim 1, wherein the interconnection board and the edge boards are connected respectively with two adjacent orthogonal sides of each of the processor boards.

4. The interconnection architecture of claim 1, wherein the interconnection architecture comprises two edge boards connected to two adjacent orthogonal sides of each of the processor boards.

5. The interconnection architecture of claim 1, wherein the interconnection architecture comprises two edge boards connected to two opposite sides of each of the processor boards.

6. The interconnection architecture of claim 1, wherein the interconnection architecture comprises three edge boards connected to three sides of each of the processor boards.

7. The interconnection architecture of claim 1, wherein the edge board is configured close to at least one corner of each of the processor boards.

8. The interconnection architecture of claim 1, wherein the edge board comprises a plurality of edge connectors for connecting with the processor boards.

9. The interconnection architecture of claim 8, wherein the edge board further comprises a plurality of trace connections to connect one of the edge connectors with another of the edge connectors.

10. The interconnection architecture of claim 8, wherein the edge connector is compatible with FCI Airmax connector.

11. The interconnection architecture of claim 1, wherein the interconnection board comprises a plurality of interconnection connectors to connect to the processor boards.

12. The interconnection architecture of claim 11, wherein the interconnection board comprises a plurality of trace connections to connect at least one of the interconnection connectors with at least another one of the interconnection connectors.

13. The interconnection architecture of claim 11, wherein the interconnection connector is compatible with FCI Airmax connector.

14. The interconnection architecture of claim 1, wherein each of the processor boards comprises a plurality of side connectors to connect with the interconnection board and the edge board.

15. The interconnection architecture of claim 1, wherein on each of the processor boards at least one of the processors connects with at least another one of the processors.
